(19) United States
(12) Patent Application Publication
(10) Pub. No.: US 2017/0079191 A1
(43) Pub. Date: Mar. 23, 2017

(54) LATERALLY MOVEABLE HITCH ASSEMBLY FOR A TRACTOR

(71) Applicant: Meridian Manufacturing Inc., Winnipeg (CA)

(72) Inventors: Paul Hugh Cunningham, Winnipeg (CA); Samuel John Plett, Winkler (CA); Bernie Thiessen, Winkler (CA)

(21) Appl. No.: 15/271,060

(22) Filed: Sep. 20, 2016

Related U.S. Application Data
(60) Provisional application No. 62/221,464, filed on Sep. 21, 2015.

(51) Int. Cl. A01B 63/02; A01B 63/00; A01B 63/12; A01B 59/06; A01B 63/06; A01B 63/10; B60D 1/44; A01B 59/00

(52) U.S. Cl. CPC A01B 63/023; B60D 1/44; A01B 63/004; A01B 59/002; A01B 59/06; A01B 63/06; A01B 63/1006; A01B 63/12

(57) ABSTRACT

The adjustable hitch assembly of the present invention is mounted to the 3 point hitch system or quick attach frame on the rear of a tractor, and allows equipment, tools and implements to be hitched thereto. The hitch assembly includes a frame for mounting to the tractor, a carriage slidably mounted to the frame, and a hitch plate extending rearwardly from the carriage. The hitch assembly also includes an actuator for adjusting the lateral position of the hitch plate relative to the tractor. The actuator is coupled to the hydraulic system of the tractor. The actuator can be controlled remotely from the cab of the tractor.

### CROSS REFERENCE TO RELATED APPLICATIONS

This application claims priority under 35 U.S.C. §119 to provisional application U.S. Ser. No. 62/221,464, filed on Sep. 21, 2015, herein incorporated by reference in its entirety.

### BACKGROUND OF THE INVENTIONS

Agricultural tractors often include a rear coupler, such as a 3 point hitch system or a quick attach frame, which allows various implements or tools to be attached thereto for use in the field or other applications. The coupler is connected to the hydraulic system of the tractor to control the position of the attached implement or tool.

One type of attachment sometimes used on the coupler system is a hitch plate. When mounted to the tractor coupler, the hitch plate typically has a few degrees of lateral adjustability such that the hitch plate can be swung in opposite left and right directions. Such limited movement of the hitch plate makes movement or adjustment of the attached implement or tool difficult. Also, the small pivotal movement of the hitch plate is done manually, which requires the farmer or operator to climb down from the tractor to make the adjustment and then climb back into the tractor, or requires a second person on the ground. Such manual operation takes time and is inconvenient.

Therefore, a primary objective of the present invention is a provision of a hitch assembly for use on the rear coupler system of a tractor which allows the assembly to be laterally adjusted over a relatively wide range from the tractor cab.

Another objective of the present invention is a provision of a hitch assembly mountable to a 3 point hitch or quick attach system of a tractor having a remotely controlled actuator for moving a hitch plate in opposite left and right directions.

Further objective of the present invention is a provision of a hitch assembly for a tractor 3 point hitch or quick attach system wherein the hitch plate is moveable left and right, as needed.

Still another objective of the present invention is a provision of a hitch assembly for use with a 3 point hitch or quick attach system of a tractor, including a linear actuator to laterally adjust the hitch plate.

Yet another objective of the present invention is a provision of a hitch assembly mountable to a 3 point hitch or quick attach system of a tractor which eliminates manual adjustment of the hitch plate.

A further objective of the present invention is a provision of a hitch assembly for a tractor 3 point hitch or quick attach system, which simplifies positioning of the hitch plate.

Still yet another objective the present invention is a provision of an improved hitch assembly for a tractor 3 point hitch or quick attach system, having an increased range of lateral movement of the hitch plate, compared to the prior art.

A further objective of the present invention is a provision of a hitch assembly for a tow vehicle which can be quickly and easily moved between lateral positions.

Yet another objective of the present invention is a provision of a vehicle hitch assembly which is economical to manufacture, and durable and safe in use.

These and other objections become apparent from the following description of the invention.

### SUMMARY OF THE INVENTION

The hitch assembly of the present invention is intended for use with a 3 point hitch system of an agricultural tractor. The assembly includes a frame with a cross bar extending laterally between opposite sides of the 3 point hitch or quick attach frame. A carriage is slidably mounted on the cross bar and is moveable along the cross bar. A hitch plate extends rearwardly from the carriage for hitching various implements, equipment, and/or tools. An actuator is mounted on the frame and connected to the carriage. A remote controller in the cab of the tractor controls operation of the actuator, and thus controls lateral movement of the carriage and hitch plate laterally across the rear of the tractor. The actuator may be a hydraulic cylinder, a hydraulic or electric motor, or other linear actuator for adjusting the lateral position of the carriage and hitch plate along the cross bar. The tractor driver can adjust the hitch plate from the tractor cab. The hitch assembly eliminates the need for the tractor driver to get out of the tractor to adjust the position of the hitch plate, and eliminates the need for a second person on the ground to adjust the hitch plate.

### BRIEF DESCRIPTION OF THE DRAWINGS

FIG. 1 is a perspective view of one embodiment of the hitch assembly of the present invention mounted to a 3 point hitch system of an agricultural tractor, with a hydraulic cylinder extended to move the hitch plate moved to a left side of the assembly.

FIG. 2 is a top plan view of the hitch assembly shown in FIG. 1.

FIG. 3 is a front elevation view of the hitch assembly shown in FIG. 1.

FIG. 4 is a right side elevation view of the hitch assembly shown in FIG. 1.

FIG. 5 is a perspective view of the hitch assembly with the hitch plate moved to the right side of the assembly.

FIG. 6 is a top plan view of the hitch assembly shown in FIG. 4.

FIG. 7 is a front elevation view of the hitch assembly shown in FIG. 4.

FIG. 8 is an exploded view of the hitch assembly shown in FIG. 1.

FIG. 9 is a perspective view, similar to FIG. 1, of an alternative embodiment of the hitch assembly, using a hydraulic or electric motor, rather than a hydraulic cylinder, to control the movement of the hitch plate.

FIG. 10 is top view of the embodiment shown in FIG. 9.

FIG. 11 is front elevation view of the hitch assembly shown in FIG. 9.

FIG. 12 is side elevation view of the hitch assembly shown in FIG. 9.

FIG. 13 is a perspective view of another embodiment of the invention mounted on quick attach frame.

FIG. 14 is a front elevation view of the embodiment shown in FIG. 13.

FIG. 15 is a top view plan view of the embodiment shown in FIG. 13.

FIG. 16 is side elevation view of the embodiment shown in FIG. 13.

FIG. 17 is an enlarged view taken along lines 17-17 of FIG. 13.

FIG. 18 is a sketch showing the hitch assembly of the present invention mounted to the 3 point hitch system of a farm tractor.

### DESCRIPTION OF THE INVENTION

The hitch assembly of the present invention is generally designated in the drawings by the reference numeral 10. The hitch assembly 10 is adapted to be mounted to the 3 point hitch system 12 of a tractor (not shown). The 3 point hitch system 12 includes an upper arm 14, and lower left and right arms 16, 18. The 3 point hitch system is connected to the hydraulic or electric system of the tractor. The 3 point hitch system 12 is conventional, and does not form a part of the present invention.

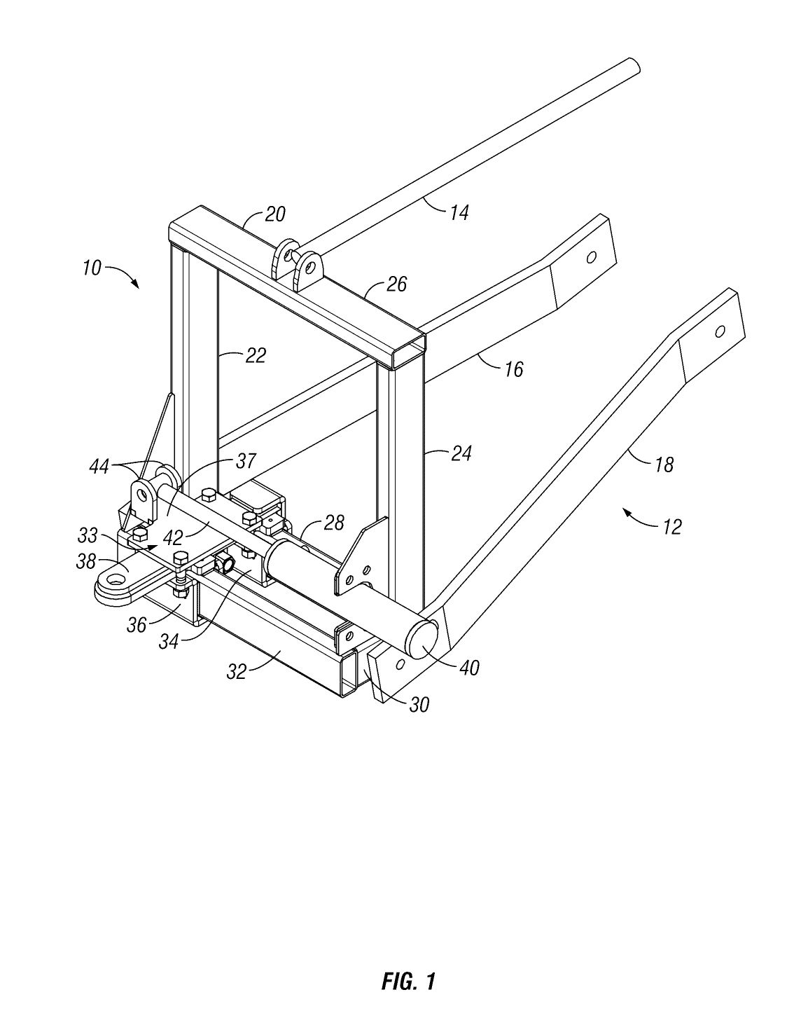

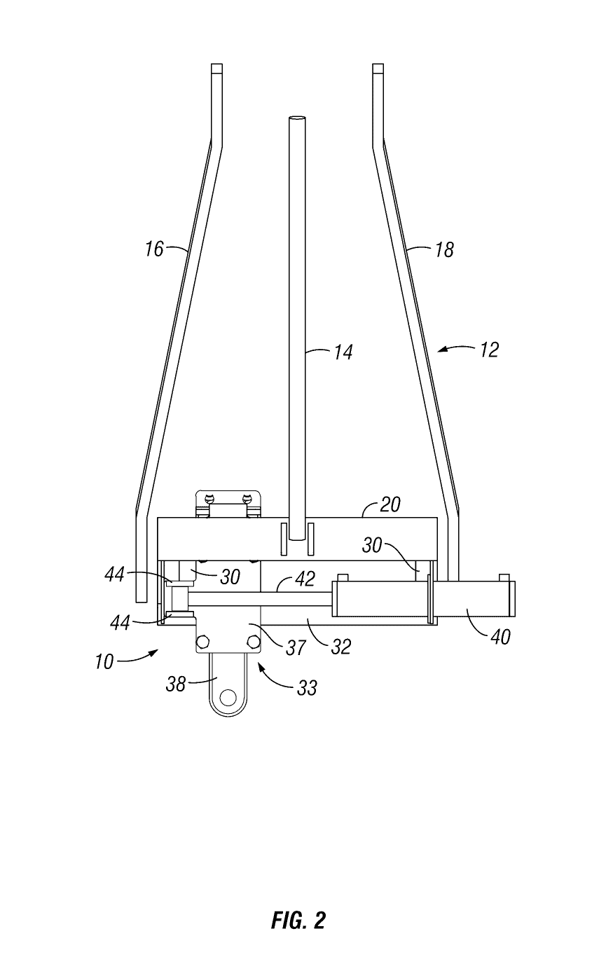

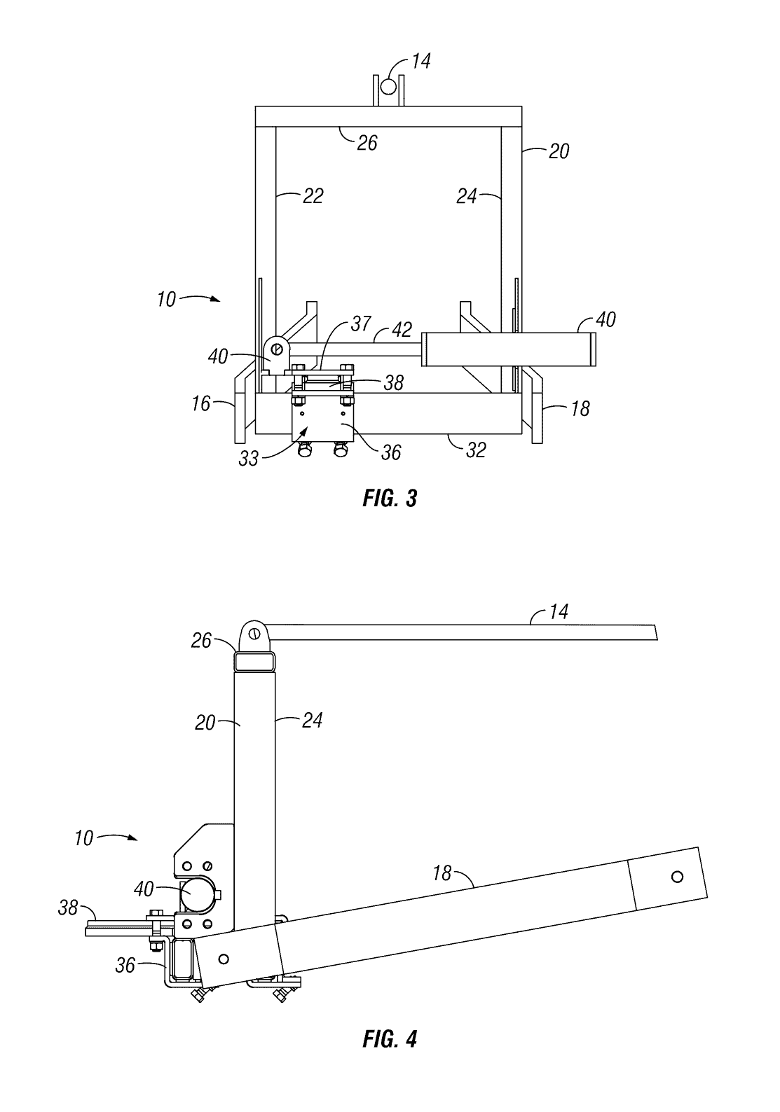

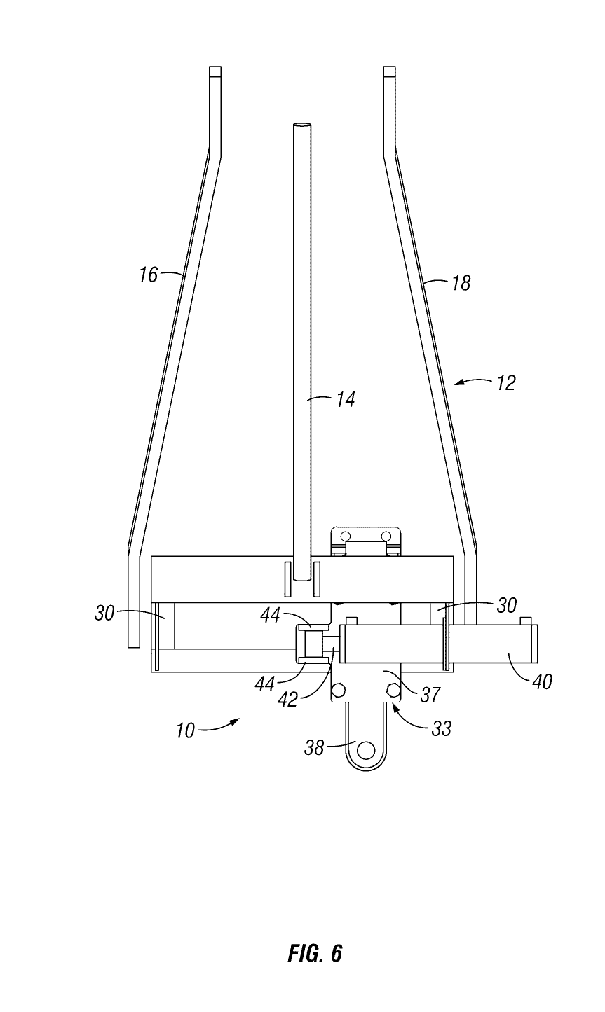

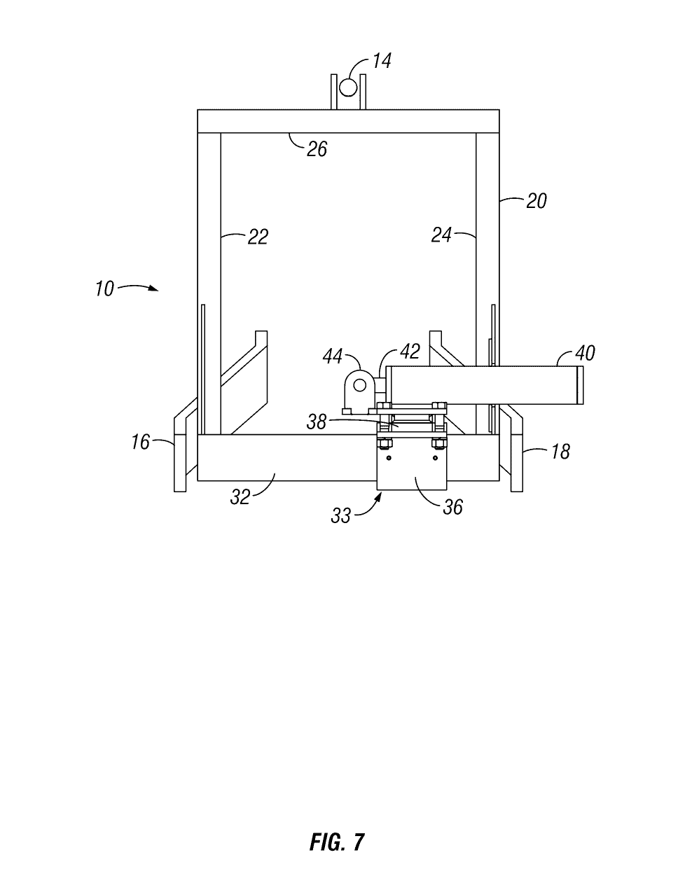

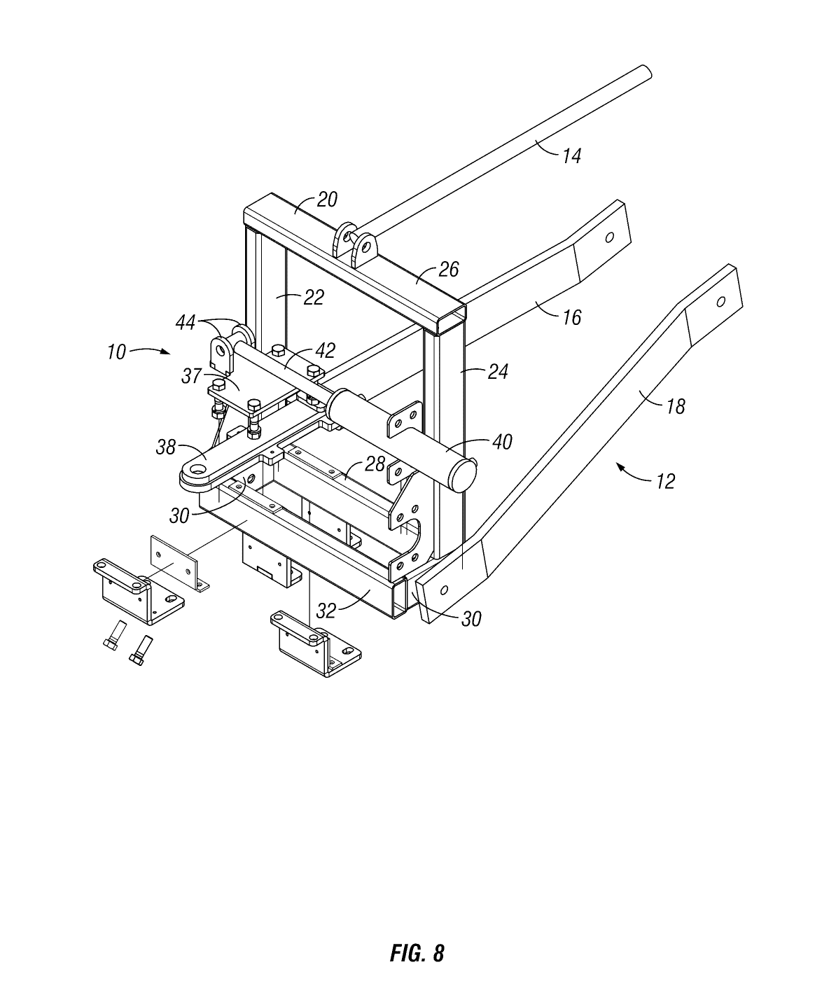

The hitch assembly 10 includes a frame 20, which may take various configurations. In one embodiment shown in FIGS. 1-8, the frame 20 includes upright lateral sides 22, 24 an upper cross bar 26, and a lower cross bar 28, all welded or otherwise connected together to form a ridged structure. A pair of legs 30 extend rearwardly from the lower cross bar 28, with another cross bar 32 extending between the legs 30. A hitch carriage 33 comprises a pair of tubes 34, 36 and an interconnecting plate 37. The tubes 34, 36 are slidably mounted on the cross bars 28, 32, respectively. While the drawings show the tubes 28, 32 formed from multiple parts, it is understood that the tubes can have a 1-piece or integral construction. The inside of the tubes 34, 36 may include material to reduce friction between the tubes 34, 36 and the bars 28, 32. The hitch plate 38 is sandwiched between the tubes 34, 36 and the plate 37, and welded or otherwise fixed so as to extend rearwardly beyond the cross bar 32.

The frame 20 of the hitch assembly 10 is open in the middle or central area, which allows the PTO shaft to extend there through for connection to other equipment.

An actuator 40 is mounted on the hitch assembly 10 and attached to the hitch plate 38 to control movement of the hitch plate 38 along the cross bars 28, 32. In the embodiment shown in FIGS. 1-8, the actuator 40 is in the form of a hydraulic cylinder having an extensible and retractable arm 42. The outer end of the arm 42 is pinned between a pair of ears or tabs 44 extending upwardly from the hitch plate 38. The hydraulic cylinder 40 is operatively connected to the hydraulic system of the tractor so that the arm 42 can be extended and retracted. Preferably, the actuator 40 is controlled remotely from the cab of the tractor 43, without requiring the operator to get out of the tractor. Any convenient remote controller 45 can be used in the tractor cab.

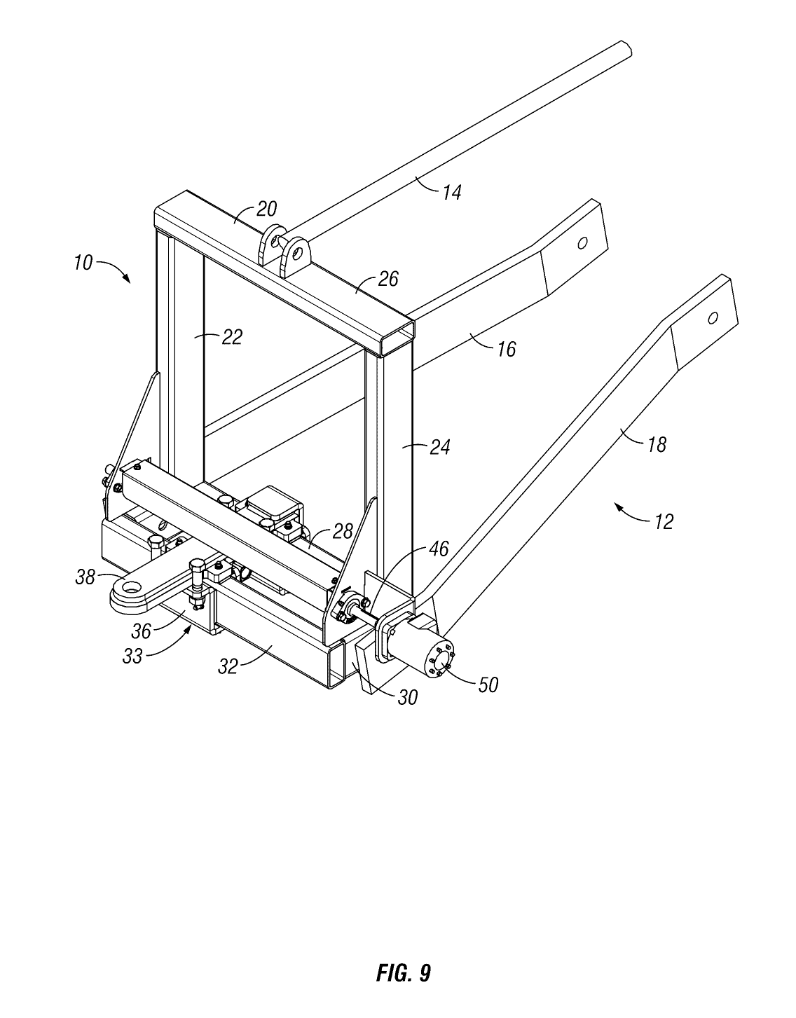

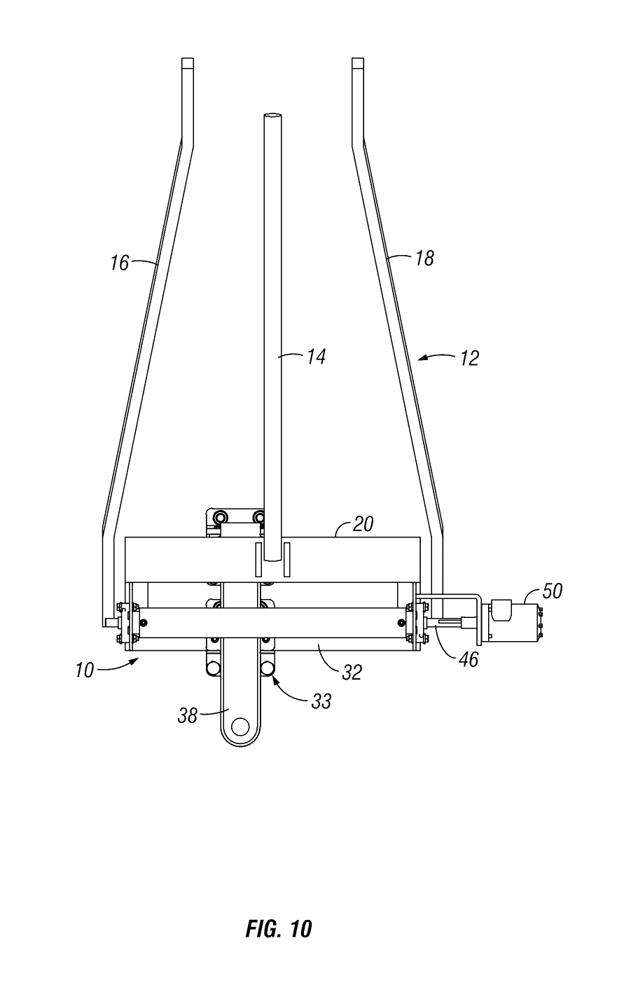

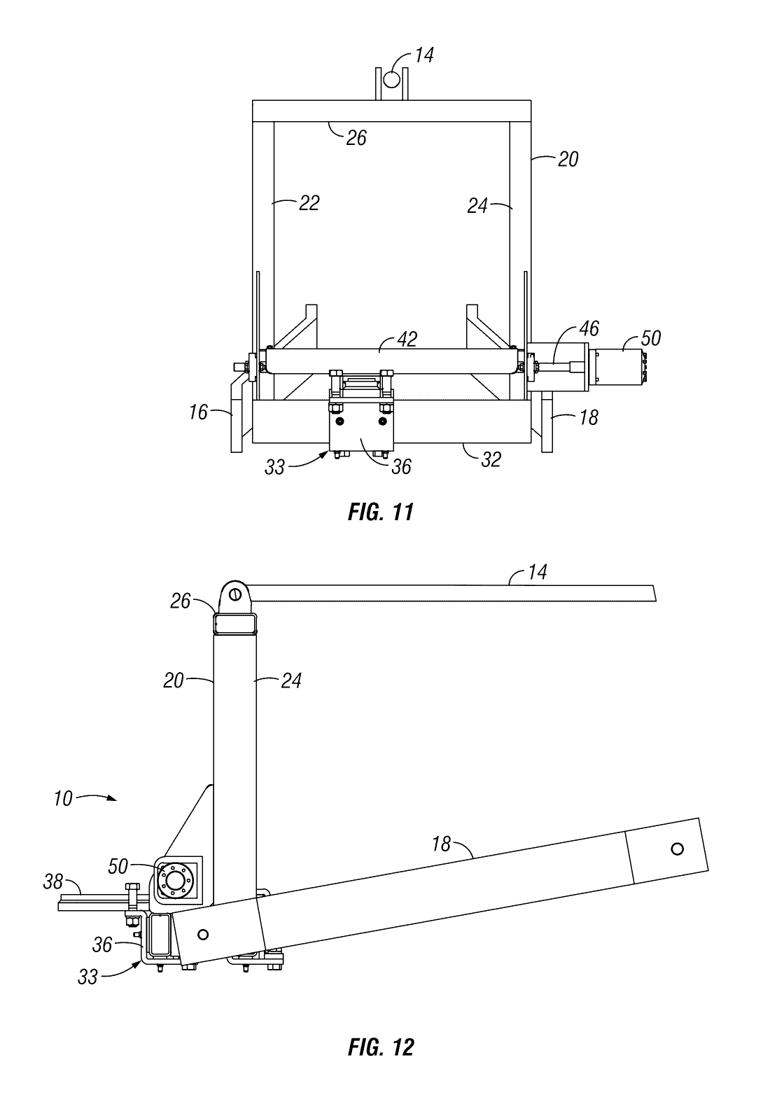

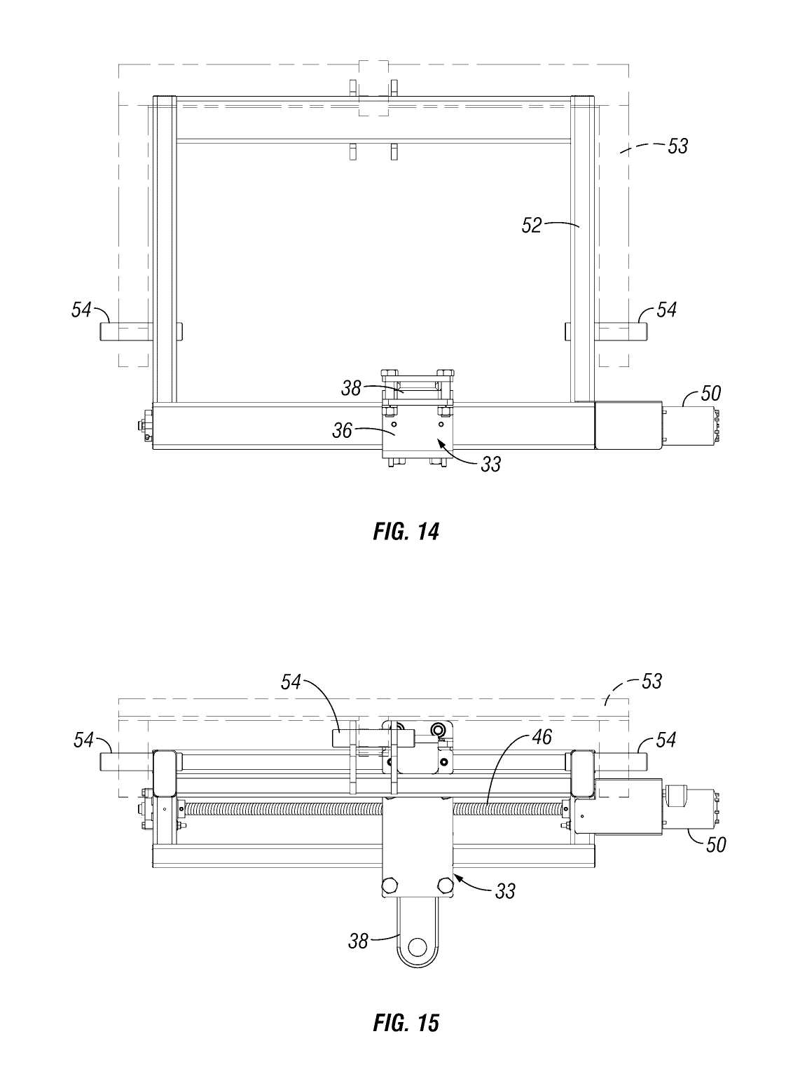

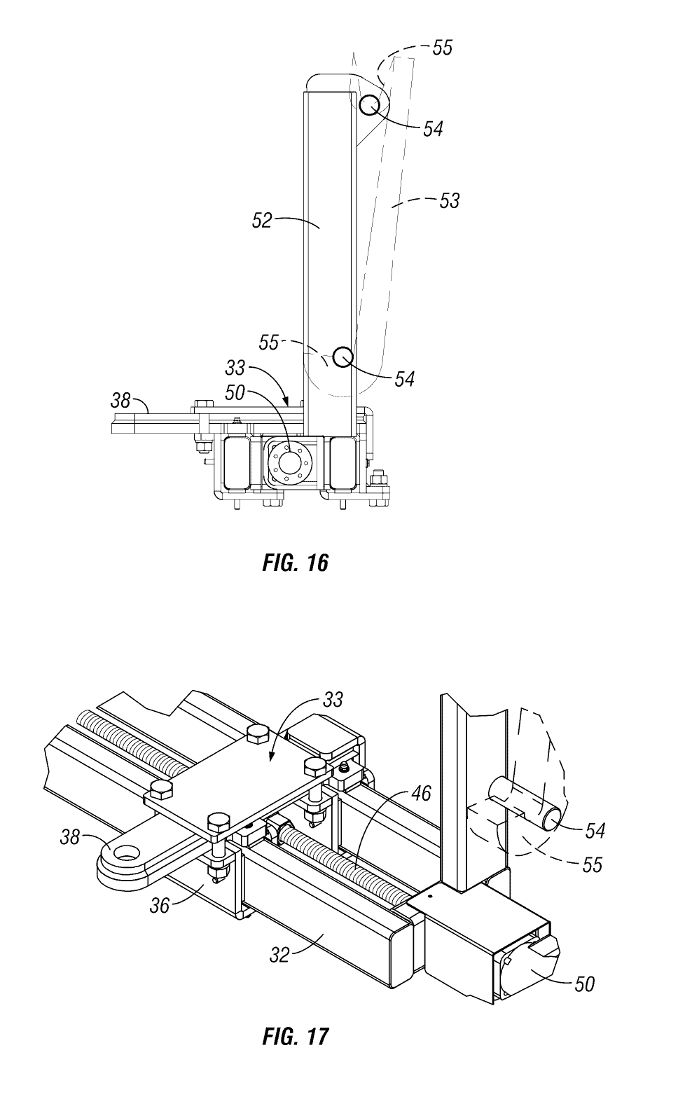

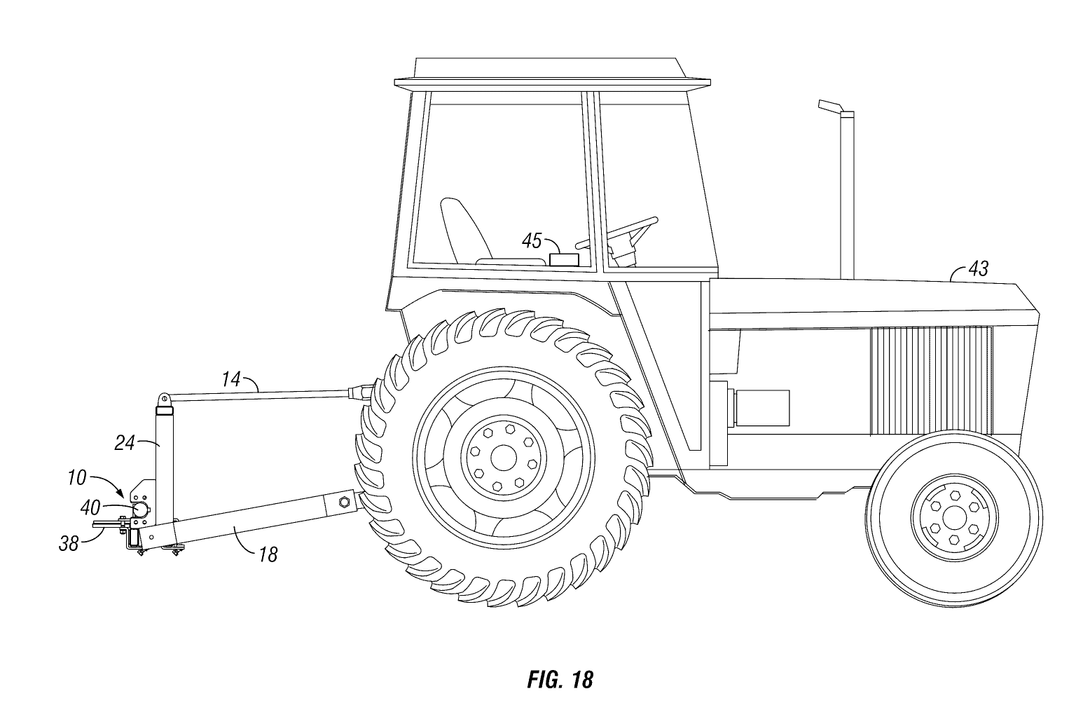

In an alternative embodiment shown in FIGS. 9-17, the actuator 40 is in the form of a threaded rod 46 and nut 48 driven by a hydraulic or electric motor 50 which rotates the rod 46. The nut 48 is welded to the assembly 10. Remote control of the motor 50 from the tractor cab makes adjustment of the assembly 10 convenient.

In yet another alternative embodiment, the actuator 40 may be a sprocket and chain driven by a hydraulic motor controlled from the tractor cab using the hydraulic controls on the tractor. The chain position would be fixed, while the motor would be mounted on a sliding portion of the assembly 10.

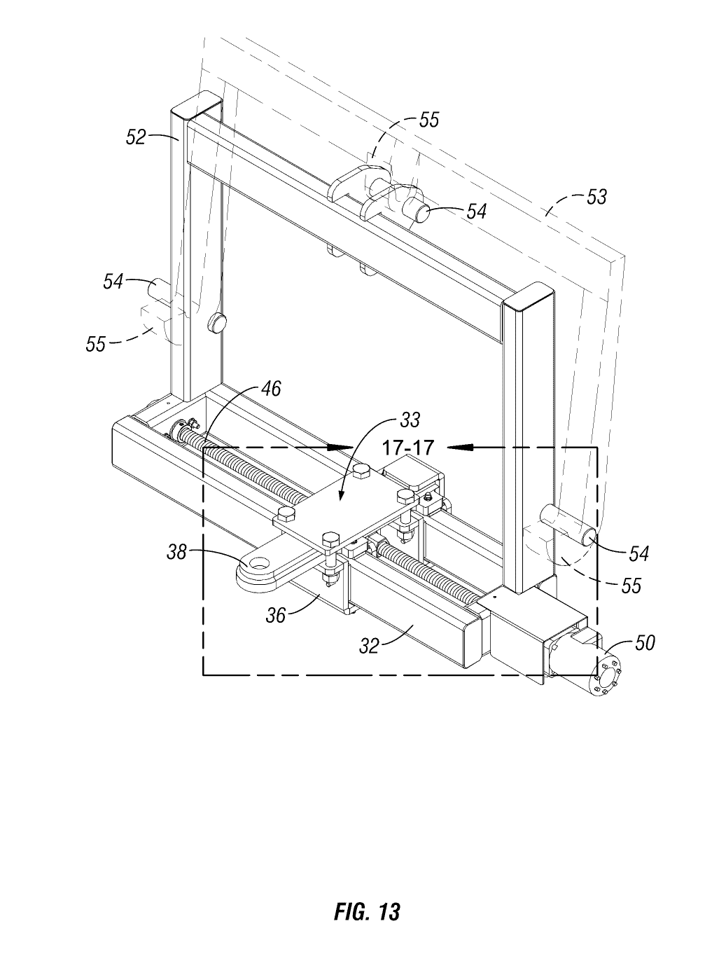

FIGS. 13-17 show an alternative mounting arrangement for the hitch assembly 10, wherein a quick attach frame 53 with hooks 55 is provided on the rear of the tractor. The hitch assembly frame 20 includes pins 54 for receipt in the hooks for mounting the assembly 10 onto the frame 53.

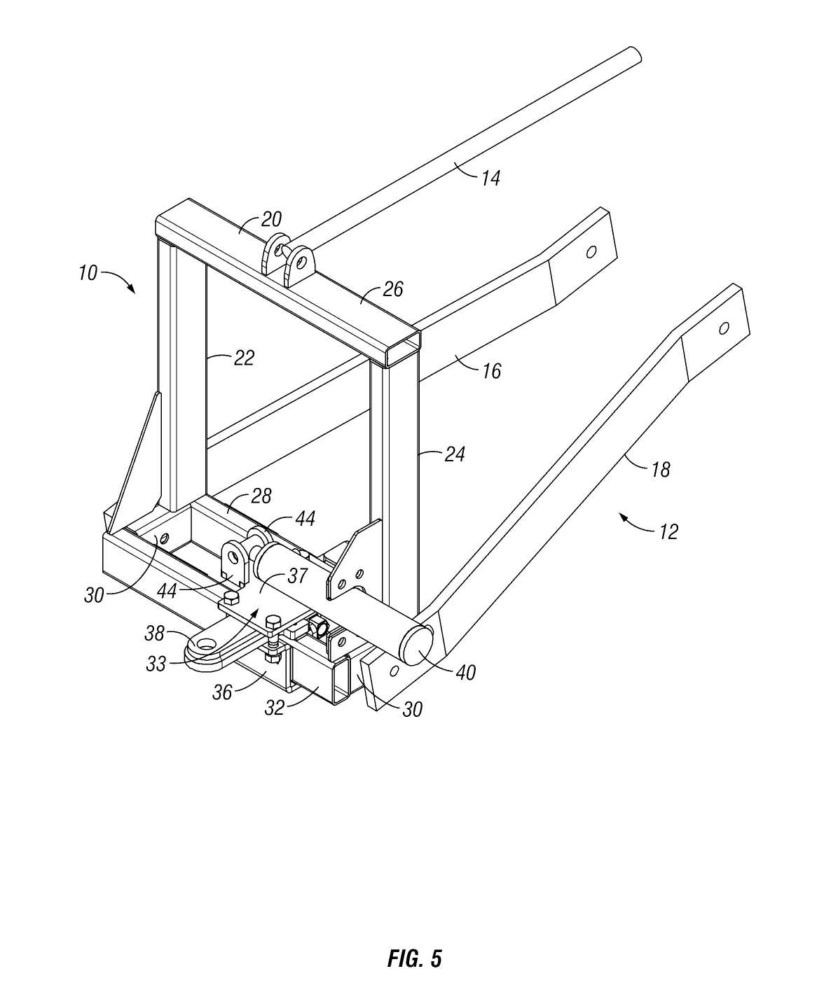

In use, the actuator 40 can be actuated from the tractor cab to position the carriage 33 with the hitch plate 38 anywhere along the cross bar 32. For example, when the cylinder arm 42 is fully extended, as shown in FIGS. 1-3, the hitch plate 38 is moved laterally to the left, as viewed from a position behind the hitch assembly 10. When the cylinder arm 42 is fully retracted, as shown in FIGS. 5-7, the hitch plate 38 is moved to the right. This lateral adjustment of the hitch plate 38 allows for quick and easy positioning of implements and tools attached to the hitch plate. In the alternative embodiment of FIGS. 9-17, the motor 50 is reversible, such that rotation of the rod 46 by the motor in one direction moves the hitch plate 38 laterally in one direction, and rotation of the rod 46 in an opposite direction moves the hitch plate 38 in the opposite lateral direction.

In one application, the lateral movement of the hitch assembly 10 allows the discharge end of a grain auger to be moved several inches to assist in lining up the auger with the opening of a bin. Mounting the hitch assembly 10 on the 3 point hitch system 12 also allows the hitch plate 38 to be raised and lowered, as needed, for example between a raised position for towing or transport, and a lowered position for use.

The invention has been shown and described above with the preferred embodiments, and it is understood that many modifications, substitutions, and additions may be made which are within the intended spirit and scope of the invention. For example, the adjustable hitch assembly 10 can be used on other types of tow vehicles, and is not limited to use with an agricultural tractor. From the foregoing, it can be seen that that present invention accomplishes at least all of its stated objectives.

What is claimed is:

1. A hitch assembly for a coupler on the rear of a tractor, comprising:
a frame mounted to the coupler and having a cross bar extending laterally between opposite sides of a coupler;
a hitch plate slidably mounted on the cross bar and movable along the cross bar, and
an actuator attached to the frame and to the hitch plate to move the hitch plate to selected positions along the cross bar.

2. The hitch assembly of claim 1 further comprising a remote controller for actuating the actuator to move the hitch plate laterally.

3. The hitch assembly of claim 1 further comprising a control system in the cab of the tractor.

4. The hitch assembly of claim 1 wherein the actuator is a hydraulic cylinder with an extendable and retractable arm.

5. The hitch assembly of claim 1 wherein the actuator includes a reversible motor.

6. The hitch assembly of claim 1 wherein the actuator includes a rotatable threaded rod with a follower nut.

7. The hitch assembly of claim 1 wherein the hitch plate extends rearwardly from a carriage slidable mounted on the cross bar for lateral movement.

8. A hitch assembly for a vehicle, comprising:
a bar adapted to mount to a rear of the vehicle and extend laterally;
a hitch plate on the bar; and
an actuator to move the hitch plate in opposite lateral directions along the bar.

9. The hitch assembly of claim 8 wherein the hitch plate moves left and right along the bar.

10. The hitch assembly of claim 9 wherein the actuator is hydraulically controlled.

11. The hitch assembly of claim 8 wherein the actuator is a hydraulic cylinder with an extendable and retractable arm connected to the hitch plate.

12. The hitch assembly of claim 8 wherein the actuator includes a reversible motor operatively connected to the hitch plate.

13. The hitch assembly of claim 12 wherein the actuator includes a threaded rod rotatably coupled to the motor and coupled to the hitch plate such that rotation of the rod in opposite directions moves the hitch pate in opposite directions.

14. The hitch assembly of claim 8 wherein the vehicle is an agricultural tractor with a hydraulic 3 point hitch system, and the bar is adapted to be coupled to the 3 point hitch system.

15. A method of laterally adjusting the position of a hitch plate, comprising mounting a frame to a vehicle;
slidably mounting a hitch plate to the frame;
actuating an actuator mounted on the frame and connected to the hitch plate so as to move the hitch plate laterally relative to the vehicle.

16. The method of claim 15 further comprising actuating the actuator in opposite directions to move the hitch plate in opposite lateral directions.

17. The method of claim 15 wherein the actuator is hydraulically or electrically actuated.

18. The method of claim 15 wherein the actuator extends and retracts.

19. The method of claim 15 wherein the actuator rotates.

20. The method of claim 15 wherein the vehicle is an agricultural tractor with a rear coupler, and the frame is mounted to the rear coupler.
